(19) United States
(12) Patent Application Publication
(10) Pub. No.: US 2007/0083924 A1
(43) Pub. Date: Apr. 12, 2007

(54) System and method for multi-stage packet filtering on a networked-enabled device

(76) Inventor: HongQian Karen Lu, Austin, TX (US)

Correspondence Address: Pehr Jansson;#202, 9501 N. Capital of TX Hwy., Austin, TX, 78759, US

(21) Appl. No.: 11/246,736

(22) Filed: Oct. 8, 2005

(51) Int. Cl. G06F 15/16; G06F 17/00; G06F 9/00

(52) U.S. Cl. 726/13; 726/14

(57) ABSTRACT

A multi-stage packet filtering method and system. The multi-stage packet filtering according to the invention applies a set of filtering rules early in the processing of incoming communications packets by filtering incoming data packets using the filtering rules in a plurality of stages wherein the first stage is triggered by the receipt of a data packet by the device. Filtering rules that cannot be applied in the first stage may be deferred to a pre-memory allocation stage. Thus, preferable leaving only rules that must be executed in conjunction with protocol processing to be filtered at a filtering stage executed in a protocol processing filtering stage.

### TECHNICAL FIELD OF THE INVENTION

The present invention relates generally to data communications and more particularly to packet filtering of incoming data packets in a network-enabled device.

### BACKGROUND OF THE INVENTION

Unauthorized intrusion into computer networks and into devices that are connected to computer networks is one of the most vexing problems of the information age. There are numerous accounts of private data being appropriated by unauthorized individuals and many instances wherein computers and networks have been compromised by data that was introduced into these computers and networks by third parties who lacked authority to do so. Furthermore, with the high level of connectivity of the modern world, there is a high risk of inadvertent attempts to access computers that are in fact not intended for such access.

Firewalls represent one mechanism for protecting connected computer devices from unauthorized access. Firewalls are hardware or software devices that protect the network and the devices on one side (inside the firewall) of the firewall by preventing some forbidden communications from passing through. Typically, a firewall filters out the communications items that possess any unauthorized criteria and only allows through those items that fall through all the filters, thus, not possessing any of the unallowable characteristics.

One type of firewall is known as Packet Filtering. Packet filtering refers to the technique of controlling access to a network or networked device by analyzing incoming and outgoing data packets based on information in protocol headers. Packet filtering is a well-known firewall technique that has been described in the technical literature, e.g., Cheswick, W. R., Bellovin, S. M. and Rubin, A. D., Firewalls and Internet Security, Addison-Wesley, 2003; Zwicky, E. D., Cooper, S. and Chapman D. B., Building Internet Firewalls, O'Reilly, 2000; Lockhart, A., Network Security Hacks, O'Reilly, 2004. The packet filtering is typically performed at Ethernet, IP, and TCP/UDP layers, that is, at the protocol processing stage.

Extensive research on packet filtering in the past twenty years has produced excellent results and made many applications possible, such as network monitoring, traffic collection, performance measurement, packet classification in routers, firewall filtering and intrusion detection. Recent research on packet filtering may be found in J. Mogul, R. Rashid, and M. Accetta. The Packet Filter: An Efficient Mechanism for User-level Network Code. In Proceedings of the Eleventh ACM Symposium on Operating Systems Principles, pages 39-51, November 1987; S. McCanne and V. Jacobson. The BSD Packet Filter: A New Architecture for User-level Packet Capture. In Proceedings of the Winter 1993 USENIX Conference, pages 259-290, January 1993; A. Begel, S. McCanne, S. L. Graham. BPF+: Exploiting Global Data-flow Optimization in a Generalized Packet Filter Architecture. In Proceedings of SIGCOMM, pages 123-134, August 1999; M. L. Bailey, B. Gopal, M. A. Pagels, L. L. Peterson, and P. Sarkar. PATHFINDER: A Pattern-Based Packet Classifier. In Proceedings of the First USENIX Symposium on Operating Systems Design and Implementation, pages 115-123, November 1994; and D. R. Engler and M. F. Kaashoek. DPF: Fast, flexible demultiplexing using dynamic code generation. In Proceedings of SIGCOMM, pages 53-59, August 1996. The prior art research has typically focused on flexible, extensible, and generalized filter abstractions and how to compile the high-level abstractions to efficient implementations. Furthermore, the research was mostly based on modern operating systems and computing systems, such as workstations (in the past) and personal computers (at present). The packet filter is normally one module of the operating system, which executes at the protocol processing stage or is parallel to the protocol processing module, see e.g., S. McCanne and V. Jacobson (cited above).

While the Internet is primarily a network of full-fledged computers, with networking functionality added to devices that hitherto were not capable to act as autonomous network nodes, it is becoming increasingly common for various resource-constrained devices to join the Internet. One example of a class of such devices is Network Smart Cards. Network smart cards, which are described in co-pending patent application Ser. No. 10/848,738 “SECURE NETWORKING USING A RESOURCE-CONSTRAINED DEVICE”, filed on May 19, 2004, the entire disclosure of which is incorporated herein by reference, combine the functionality of traditional smart cards with the capability of acting as autonomous network nodes by implementing a communications protocol stack used for network communication. Because these resource-constrained devices can connect to the Internet they are also vulnerable to network security threats much like their full-fledged computer peers. Accordingly, the network-enabled resource-constrained devices also require protection from security threats, e.g., firewalls. However, because of the resource constraints, such as limited memory space, reduced computational power, and limited I/O capabilities, of network-enabled resource-constrained devices, prior art firewall implementations may not be ideally suited for implementation on such devices.

Resource-constrained network devices typically have a very limited memory resource. Because the prior art packet filtering techniques typically operate as part of the processing of particular communications protocols, memory has already been allocated for the incoming data packet before the filtering has occurred. This presents a problem for resource-constrained devices because once connected to a network, the device may face a large number of unwanted messages. If not managed well, the memory buffer of the device can overflow very quickly and render the device inoperable.

From the foregoing it is apparent that there is a need for a packet filtering technique that is particularly tailored to work within the limitations of network-enabled resource-constrained devices, such as network smart cards. Such a packet filtering method should to the greatest extent possible avoid allocating memory for and avoid wasting unnecessary processor resources on undesirable communications packets.

### SUMMARY OF THE INVENTION

In a preferred embodiment, the invention provides a system and method for applying packet filtering rules at a very early stage thereby avoiding allocating memory resources for and expending unnecessary processor resources on undesirable communications packets.

A method and system for packet filtering according to the invention applies a set of filtering rules early in the processing of incoming communications packets by filtering incoming data packets using the filtering rules in a plurality of stages wherein the first stage is triggered by the receipt of a data packet by the network-enabled device. In an embodiment of the invention, the first stage is carried out in an interrupt service routine triggered by an incoming data packet. The filtering rules includes rules classified based on whether the filtering rule is a dynamic rule that tests a packet against dynamic variables or a static rule that tests a packet against constants or variables that do not change during a session of the network-enabled device. In an embodiment of the invention, the first stage executes as part of an interrupt service routine for handling the incoming data packet applies static rules and filtering rules that include dynamic variables are applied during a pre-memory allocation packet filtering stage.

Filtering rules may also be classified by as those filtering rules that depend on traffic history and those filtering rules that do not depend on traffic history. For some protocols, such rules may be referred to as stateful and stateless, respectively. In an embodiment of the invention, the filtering rules that do not depend on traffic history are applied in a pre-memory allocation packet filtering stage and the filtering rules that do depend on traffic history are applied during a protocol specific packet filtering stage.

By applying filtering rules at a very early stage of the processing of incoming data packets, the invention avoids unnecessary allocation of memory and waste of processor resources on undesirable packets. Security advantages are also achieved in that undesirable data packets are eliminated early in the processing, thereby reducing the risks associated with having such packets causing some harm.

Other aspects and advantages of the present invention will become apparent from the following detailed description, taken in conjunction with the accompanying drawings, illustrating by way of example the principles of the invention.

### BRIEF DESCRIPTION OF THE DRAWINGS

FIG. 1 is a schematic illustration of the operating environment in which a network smart card device according to the invention may be used to provide reliable communication with a remote entity.

FIG. 2 is a schematic illustration of an exemplary architecture of the hardware of a network smart card that may be used in conjunction with the invention.

FIG. 3 is a schematic illustration of one example of certain hardware and software elements of a network-enabled resource constrained device that is connected to a host device.

FIG. 4 is an illustration of an example of protocol encapsulation of communications protocols that may be processed in conjunction with the invention.

FIG. 5 is a schematic diagram illustrating the classification of filtering rules according to whether the rules are static or dynamic, and whether the rules are stateful or stateless.

FIG. 6 is a timing-sequence diagram illustrating a first application of a multi-stage packet filtering system of the present invention.

FIG. 7 is a timing-sequence diagram illustrating an alternative workflow for a multi-stage packet filtering system according to the invention.

FIG. 8 is a flow chart illustrating an example sequence for the operation of the ISR packet filtering stage.

FIG. 9 is a block diagram illustrating some of the software modules for implementing the multi-stage packet filtering method of the invention and that may be stored, for example, in the NVM of a network-enabled device incorporating the functionality provided by the present invention.

### DETAILED DESCRIPTION OF THE INVENTION

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. For example, a particular feature, structure, or characteristic described herein in connection with one embodiment may be implemented within other embodiments without departing from the spirit and scope of the invention. In addition, it is to be understood that the location or arrangement of individual elements within each disclosed embodiment may be modified without departing from the spirit and scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views. In several instances herein, similar devices are referred to using reference numerals that are appended with a prime or double prime (i.e., “or”), or with suffixes “a”, “b”, or “c”, e.g., 101′, 103′, 301a, 301b, 301c. Such devices having the same base number are either different instantiations of the same type of device or functionally equivalent to one anther for the purposes of this invention. Herein, if a reference numeral is used without the suffix, it is to be taken as applying to all instances with a suffix or prime designation unless explicitly stated to the contrary.

1.0 Introduction

As shown in the drawings for purposes of illustration, the invention is embodied in a network enabled resource-constrained device, e.g., a network smart card, equipped with the capability of performing packet filtering in multiple stages, thereby, filtering out undesirable packets as early as possible and avoiding unnecessary memory allocation. A multi-stage packet filter of such a device provides a method, for example, implemented in software, to apply certain filtering rules during an Interrupt Service Routine triggered by an incoming data packet, other filtering rules during a pre-memory allocation packet filtering stage, and defers other filtering rules to a protocol specific packet filtering stage. By applying the novel multi-stage filtering approach of the present invention undesirable data packets are filtered out as early as possible and in many instances before memory allocation for the incoming data packet thereby providing a methodology for packet filtering suitable for use in network-enabled resource-constrained devices.

2.0 Design Overview

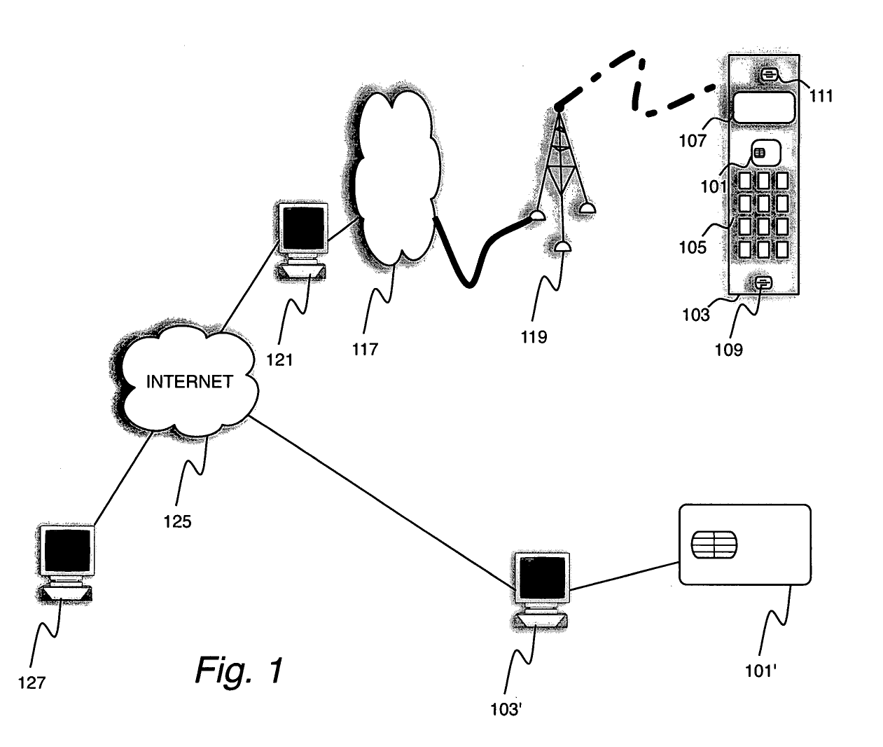

FIG. 1 is a schematic illustration of the operating environment in which a network smart card device according to the invention may be used to provide reliable communication with a remote entity. The present invention is described in the context of network smart cards for the purposes of providing an explanation of an embodiment of the invention and should not be construed as a limitation. The invention is also applicable for use in other devices, including other network-enabled resource-constrained devices, and is not necessarily limited in use to resource-constrained devices.

In one example, a network smart card 101 is installed into a handset 103. The handset 103 may be a mobile telephone having the usual accoutrements of a mobile telephone such as a keypad 105, a display 107, a microphone 109 and a speaker 111. In alternative embodiments, the handset 103 may be a personal digital assistant or any other mobile device using a SIM card. The handset 103 also contains an electronic circuitry (not shown) including a central processing unit and memory. Furthermore, there are a variety of smart mobile devices available, such as web-enabled phones, smart phones, PDAs, handheld PCs and tablet PCs. Many of the smart phones and PDAs combine the cell phone and PDA functionalities. Popular operating systems for smart mobile devices include Symbian, Palm OS, and Microsoft Smartphone. The invention described herein is applicable to such devices if they have SIM device that is a network smart card 101.

The electronic circuitry provides communications functionality for the handset 103 with a wireless network 117 via a wireless link to a wireless telephony antenna 119. And the microprocessor provides some of the control functionality of the handset 103, such as managing operations of the handset 103 and managing communications protocols used to communicate with the wireless network 117. The network smart card 101 is connected to the electronic circuitry so as to allow communication between the network smart card 101 and the handset 103.

The wireless network 117 is composed of a complex communications infrastructure for providing connections to other stations, for example, other mobile stations or land-based telephone systems. One such station may be an Internet gateway 121, which gives the wireless network 117 access to the Internet 125. As commonly known, very many computers are connected via the Internet. In the scenario presented herein, a user of a handset, e.g., a mobile telephone or a PDA, uses the infrastructure illustrated in FIG. 1 to communicate with the network smart card 101 either via the handset 103 or some other computer connected to the Internet 125. Some aspect of this communication uses direct communication between the network smart card 101 and the remote entity 127, for example, for the purpose of communicating some information that is stored on the network smart card 101 to the remote entity 127.

Another example is a network smart card 101′ having a credit card form factor and which is connected to the Internet 125 via a host computer 103′.

A network smart card 101 or 101′ is a smart card that is capable to act as an autonomous Internet node. Network smart cards are described in co-pending patent application Ser. No. 10/848,738 “SECURE NETWORKING USING A RESOURCE-CONSTRAINED DEVICE”, filed on May 19, 2004, the entire disclosure of which is incorporated herein by reference. A network smart card 101 implements Internet protocols (TCP/IP) and security protocols (SSL/TLS) built into the card and may implement other communications protocols as described herein below. The network smart card 101 can establish and maintain secure Internet connections with other Internet nodes. The network smart card 101 does not depend on a proxy on the host to enable Internet communications. More over, the network smart card 101 does not require local or remote Internet clients or servers to be modified in order to communicate with the smart card.

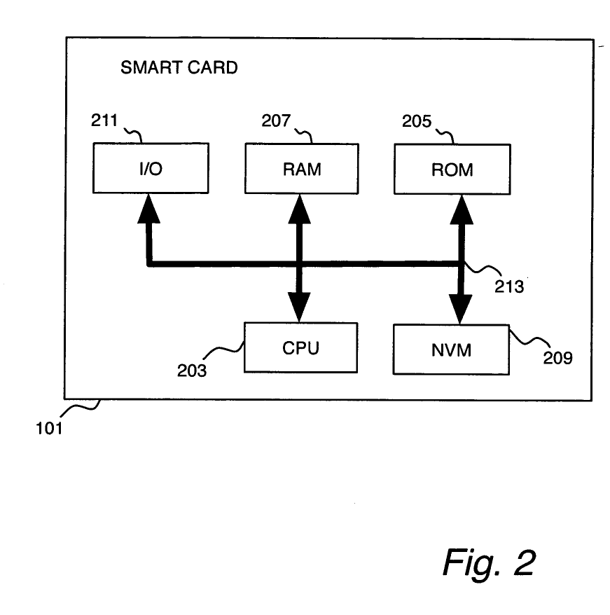

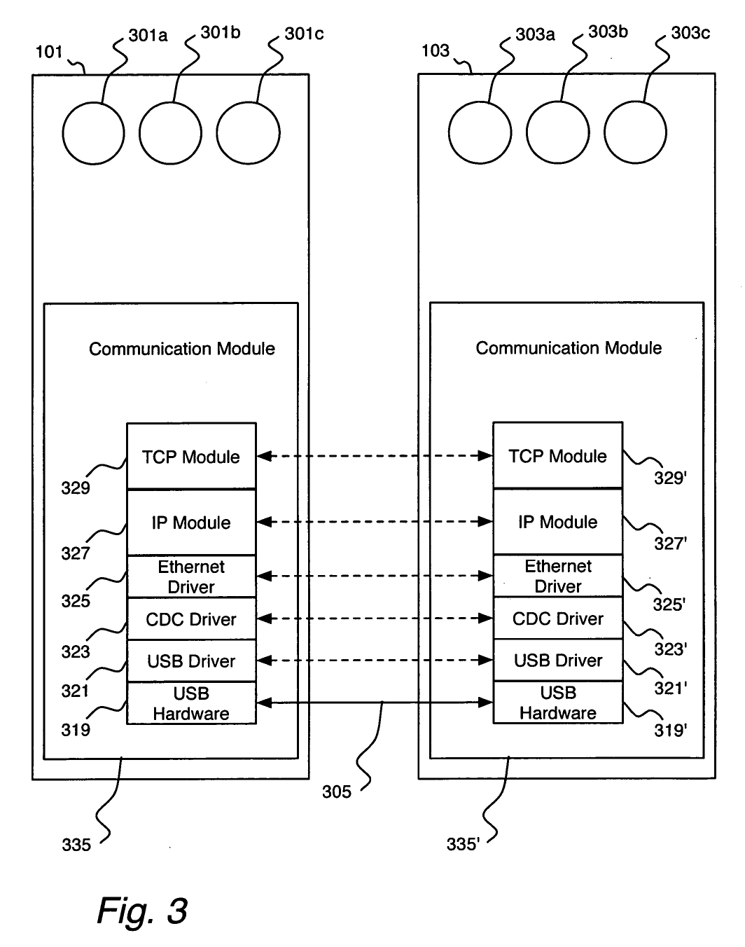

FIG. 2 is a schematic illustration of an exemplary architecture of the hardware of a network smart card 101 that may be used in conjunction with the invention. The network smart card 101 is a smart card having a central processing unit 203, a read-only memory (ROM) 205, a random access memory (RAM) 207, a non-volatile memory (NVM) 209, and a communications interface 211 for receiving input and placing output to a host computer 103, particularly the electronics of the host computer 103, to which the network smart card device 101 is connected. These various components are connected to one another, for example, by bus 213. In one embodiment of the invention, the communications module 335 (introduced in FIG. 3 below and described herein below in conjunction with FIG. 3 and other figures herein), as well as other software modules described herein below, would be stored on the resource-constrained device 101 in the ROM 205. In alternative embodiments, the software modules stored in ROM 205 would be stored in a flash memory or other types of non-volatile memory. For purposes of illustration, the invention is described using the ROM example. However, that should not be construed as a limitation on the scope of the invention and wherever ROM is used, flash memory and other types of non-volatile memory can be substituted as an alternative.

The ROM 205 would also contain some type of operating system, e.g., a Java Virtual Machine. Alternatively, the communications module 335 would be part of the operating system. During operation, the CPU 203 operates according to instructions in the various software modules stored in the ROM 205.

Thus, according to the invention the CPU 203 operates according to the instructions in the communications module 335 to perform the various operations of the communications module 335 described herein below.

3.0 Overview of an Embodiment of the Invention

Packet filtering method has network security as its main purpose. The present invention adheres to that goal while also addressing memory management. Both are extremely important and necessary for resource-constrained network devices. Packet filtering is typically done at protocol layers. However, allocating memory for a packet, processing the packet through layers, and then dropping the packet waste CPU and memory resources. In addition, if packets are not processed promptly, there may not be enough memory buffers for new incoming data. To avoid that problem, the present invention performs packet filtering as early as possible—ideally, before the protocol processing and memory allocation process—and filters at multiple stages starting from the hardware I/O interrupt service routines and leaving only rules that cannot be filtered before protocol processing until that time. This front-end filtering also makes the device more secure because it blocks undesirable packets before these packets have made their way into the device.

The amount of filtering at each of the multi-stages depends on multiple factors, including the filtering rules, the hardware configuration (e.g. Ethernet, USB, MMC), data link layers (e.g. Ethernet, CDC, EEM, MMC), hardware I/O interrupt mechanisms (e.g. byte, frame, DMA), and memory buffering schemes (e.g. straight buffer, chained buffer), hardware capability, and the network stack process model. Specific implementations of the invention may take these factors into account.

A packet filtering system for a network-enabled resource-constrained device 101 according to the invention drops unwanted packets as soon as possible to secure the device, to save the memory, and to reduce the CPU usage for packet processing. It offers several advantages over the existing packet filtering designs, including better security, reduced memory usage, and better performance.

4.0 Protocol Layers

FIG. 3 is a schematic illustration of one example of certain hardware and software elements of a resource constrained device 101 that is connected to a host device 103. The resource-constrained device 101 and the host device 103 each have a communications module 335 and 335′, respectively, for managing communication between the two and for communication with other entities to which the devices are connected either directly or via a network. In the example of FIG. 3, the resource-constrained device 101 communicates with the host device 103 over a USB link 305 between USB hardware modules 319 and 319′. Many other alternative communication protocols may be implemented, e.g., direct physical contacts using ISO-7816, infrared link, Ethernet, MMC. On top of the USB hardware layer are USB drivers 321 and 321′. The other layers in the protocol stack may include a CDC layer implemented by CDC drivers 323 and 323′, an Ethernet layer implemented by Ethernet drivers 325 and 325′, an IP layer implemented by IP modules 327 and 327′, and a TCP layer implemented by TCP modules 329 and 329′. In an alternative implementation, the CDC drivers on each side may be implemented using EEM drivers for implementing the EEM protocol. The data link layer handles Ethernet frames. If the hardware connection is USB, the data link layer, in addition, handles CDC or EEM frames, the CDC or EEM frames carry Ethernet frames. Similarly, if the hardware connection is MMC, the data link layer handles MMC frames as well as Ethernet frames, where the MMC frames carry Ethernet frames. The data link layer may be PPP instead of Ethernet for establishing network connection. For exemplary purposes, the present invention is described herein in the context of Ethernet frames.

The communication modules 335 and 335′ provide communications services to one or several application programs 301a-c and 303a-c. The application programs 301 may, for example, be web servers or other network applications. The application programs 303 may be web browsers for communicating with the application programs 301.

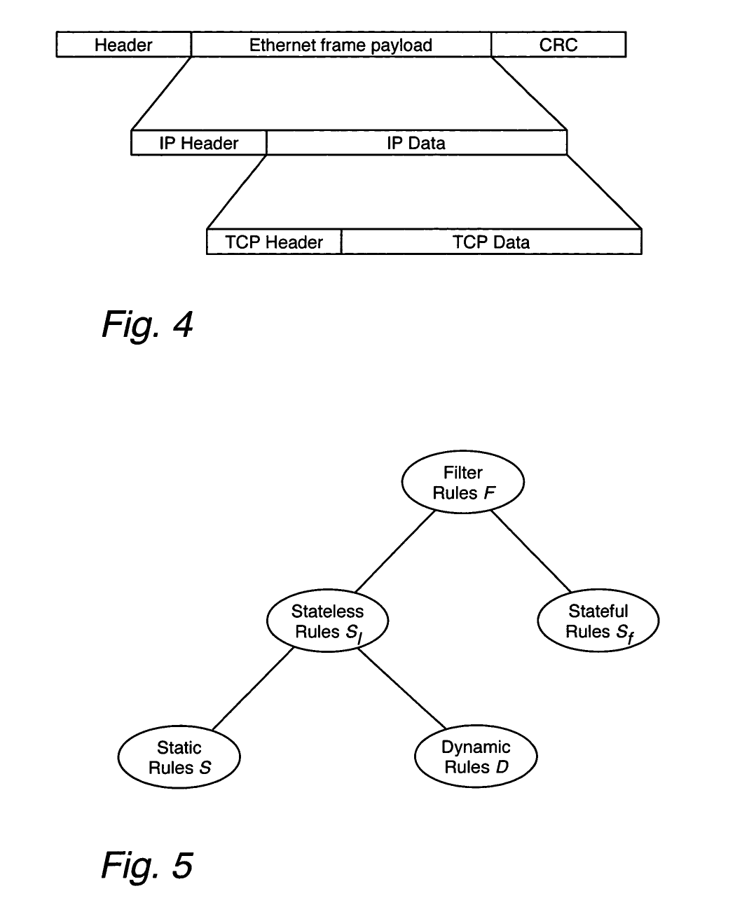

In the example of FIG. 3, the network layer is the Internet Protocol (IP). The Ethernet frames carry IP datagrams. The transport layer is TCP or UDP (the former illustrated in FIG. 3 and UDP being one alternative embodiment). IP datagrams carry TCP or UDP messages. In further alternative embodiments, the IP datagrams carry messages in other communications protocols, e.g., ICMP, IGAP, IGMP, RGMP, GGP, IP in IP encapsulation, ST, UCL, CBT, EGP, IGRP, NVP, HMP (See e.g., IP, Internet Protocol, http://www.networksorcery.com/enp/protocol/ip.htm). FIG. 4 is an illustration of an example of protocol encapsulation. A TCP/IP network is a packet-switched network. Messages are divided into packets before they are transmitted. Each packet contains the source address and the destination address. Packets can follow different routes to their destinations. Once all packets forming a message have arrived to the destination, they are recompiled into the message. In short, the TCP/IP network transmits messages via packets. Packet filtering is used to filter the packets to decide whether or not to pass the packets onto the next communications layer or to the application programs 301, or to classify the packets, or to decide where to send the packets for pre-specified purposes, e.g., to specific application programs 301. The packet filtering can be performed on in-bound packets as well as out-bound packets. The main focus herein is the filtering of in-bound packets for security purposes. In this application, the packet filtering is used to decide, for each packet, to drop or pass according to filtering rules.

5.0 Filtering Rules

Packet filtering rules specify the criteria by which a particular packet should be dropped or allowed to pass. In most cases, a packet filtering system is designed such that rules disqualify packets from passing, thus only allowing through those packets that make it past all of the relevant filtering rules. The filter rules specify packet pass or drop conditions based on information in protocol headers. The packet filters look at protocol headers of a packet and check information therein against the filter rules to decide whether to let the packet pass. I.e., referring back to FIG. 4, a packet filter rule for filtering TCP packets would look to information in the TCP header to determine whether to drop the TCP packet.

The packet filter rules are typically hierarchical because Internet protocols are layered. For example, the packet filter checks the Ethernet header against Ethernet header related filter rules, then the IP header, and then the TCP header.

As described herein, one aspect of the invention is a multi-stage packet filtering system and method. According to the invention, packets are filtered in several stages that are deployed at particular phases of the processing of an incoming data packet. Whether a rule is applied in one particular stage or another depends on certain characteristics of the particular filtering rules.

One way to classify filtering rules is by whether the rule is static or dynamic. Static filtering rules are such rules that do not depend on any information, e.g., variables, that may change during a session of resource-constrained device. For a smart card a session is a continuous period during which power is provided to the smart card, i.e., usually associated with the period during which the card is inserted into a reader or the host device provides power to the card. Dynamic filtering rules, on the other hand, are those filtering rules that depend on some parameter, e.g., a variable, that may change during the course of a session. An example of a static filtering rules would be a rule that checks for the destination MAC address of an incoming packet against the MAC address of the device 101. A MAC address of a device generally does not change. Thus, such a rule would be a static filtering rule. Another possible rule is one that checks the IP address of the source of a packet against a list of allowable sources. The allowed source IP address list would usually be a parameter that may change. Therefore, the filtering rule that checks against it would be considered a dynamic filtering rule.

Another aspect of filtering rule classification is between those filtering rules that depend on traffic history and those that do not depend on traffic history. An implementation of a TCP layer, e.g., TCP module 329, maintains a state machine in which the current state depends on the history of preceding TCP data traffic. Certain filtering rules require this state information. Such rules are referred to as stateful filtering rules. Rules that do not depend on state information are referred to as stateless filtering rules.

FIG. 5 is a schematic diagram illustrating the classification of filtering rules according to whether the rules are static or dynamic, and whether the rules are stateful or stateless. While all stateful rules S_{f} can also be classified as static or dynamic, as will seen from the discussion herein below, for the purposes of the present invention, such classification is not necessary in determining to which filtering stage a particular rule should apply.

It should be noted here that the present invention is independent of the particular rules that are applied but rather provides a framework in which the rules may be applied.

6.0 Multi-Stage Packet Filtering System and Method

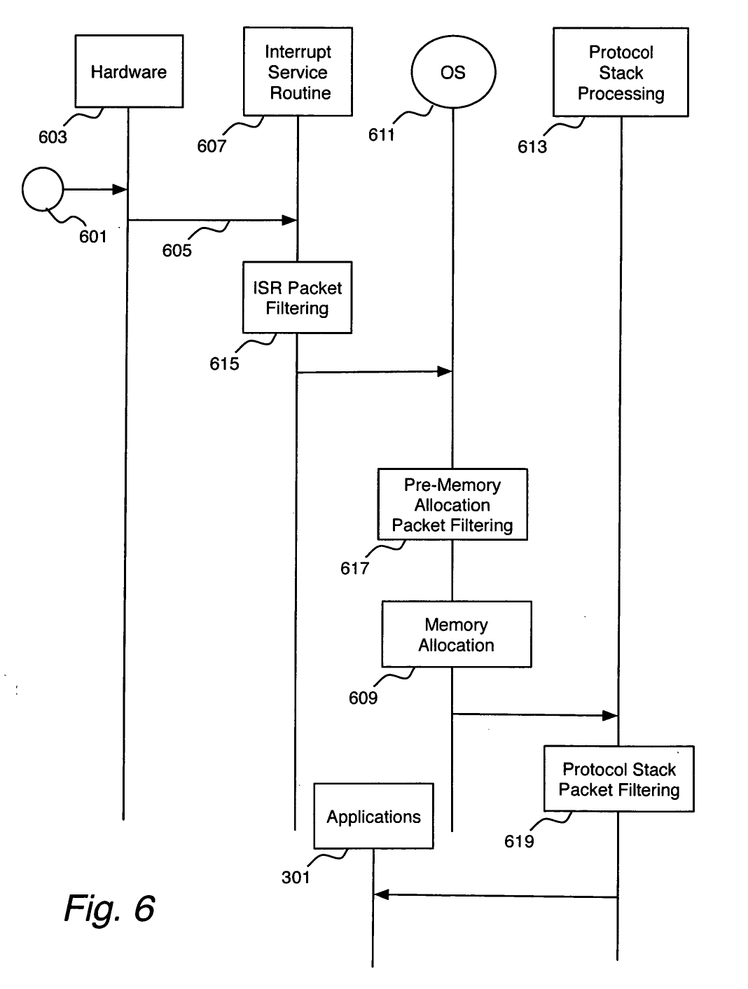

FIG. 6 is a timing-sequence diagram illustrating a first application of a multi-stage packet filtering system of the present invention. In another aspect of the this first application, the timing-sequence diagram of FIG. 6 may be viewed as a workflow for a software module or set of software modules implementing a multi-stage packet filtering system according to the invention.

When a data packet 601 arrives at the network enabled resource-constrained device 101, the I/O (input/output) hardware 603 generates an interrupt 605; or viewed from an alternative perspective, the incoming data packet 601 triggers a hardware interrupt 605. The interrupt causes the invocation of an interrupt service routine (ISR) 607. The ISR handles the interrupt to obtain the incoming data from the I/O hardware 603. This is the first stage of the packet handling. In a subsequent stage, the memory allocation stage 609 which may be performed by the operating system 611, memory space, e.g. a byte array or a buffer chain, is allocated for the packet. In a third stage, the protocol stack processing stage 613, the protocol stack processes the packet, which is a third stage. Depending on the interrupt handling, memory buffer scheme, and protocol stack, these three stages may not be completely separated and may be in a different order.

In the ISR 607 a first stage of packet filtering is performed by an ISR packet filtering module 615. By applying certain filtering rules as early as during the ISR, it is possible to reject some packets before any memory allocation for handling the packet occurs. After the ISR 607 has finished processing, control is transferred back to the OS 611. In the OS 611, memory allocation 609 is performed. However, prior to performing memory allocation 609, a pre-memory allocation packet filtering stage 617 is used to filter the incoming packet against another set of filtering rules. After memory has been allocated the OS 611 transfers control to protocol stack processing modules 613, e.g., protocol modules 321-329 of the communications module 335 for processing the various communications protocol layers. A third packet filtering stage, the protocol stack packet filtering stage 619 applies a third set of filtering rules against the incoming data packet 601. Finally, if the packet 601 has not been filtered out against any of the rules of the three packet filtering stages, the packet is passed on to the application programs 301. Thus, application of the framework illustrated in FIG. 6 results in filtering out packets at a very early stage of the processing of the packet 601, thus avoiding memory allocation and unnecessary use of computing resources for unwanted packets.

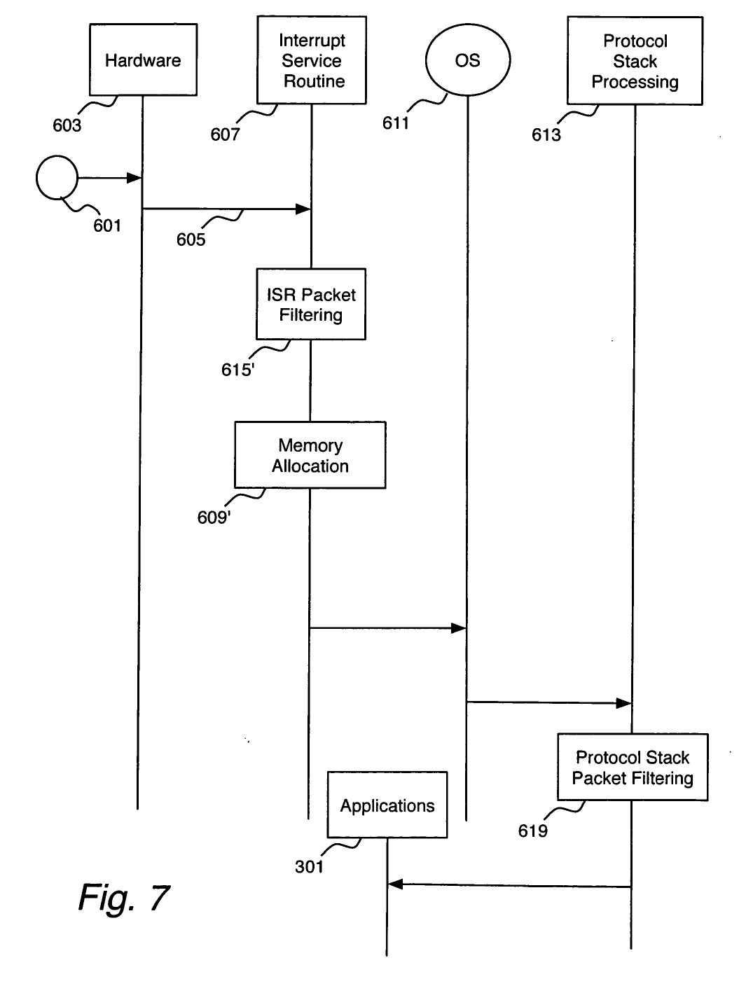

FIG. 7 is a timing-sequence diagram illustrating an alternative workflow for a multi-stage packet filtering system according to the invention. In the alternative of FIG. 7, the memory allocation 609′ is performed in the ISR 607. Thus, an ISR packet filtering stage 615′ is performed prior to the memory allocation 609′ as part of the ISR. In contradistinction to the method of FIG. 6, the timing sequence of FIG. 7 does not include a pre-memory allocation packet filtering stage as part of the OS 611. However, like the method of FIG. 6, certain packet filtering rules may still be deferred to the protocol stack processing packet filtering stage 619.

7.0 ISR Packet Filtering 615

The technical details of the generation of I/O interrupt upon receiving an incoming data packet 601 depend on the processor architecture, the I/O hardware, and the software/hardware interface that the chip manufacturer provides. The I/O interrupt service routine 607 described herein is a routine that software programmers can program to handle an interrupt. For some processors, the programmer deals with hardware interrupt service routines. For other processors, the hardware/software interface layer deals with hardware interrupts and the programmer deals with the interrupt service routine that is generated by the interface layer. Depending on the processor and the hardware/software interface layer, the interrupt service routine can be called when a byte arrives, when a packet arrives, or when a larger amount of data arrives. For example, with USB devices, the interrupt service routine is typically called when a USB packet has been received. With full speed USB bulk data transfer, this may mean that 64 bytes of data have been received.

An interrupt service routine normally does some quick and simple things to handle an interrupt. The program control returns to the routine that was interrupted as soon as possible. Typically, the ISR has timing constraints. For example, the ISR must finish before the next input event happens. For USB full speed bulk data transfer on an otherwise idle bus, the maximum possible speed per pipe is nineteen 64-byte transactions per frame, in which one frame is 1 millisecond. This takes about 82% of the bus bandwidth. Hence, the minimum time interval between the arrivals of two consecutive USB data packets is 43 microseconds. The ISR must finish within this time to allow the next USB data packet to be processed. As will be seen below, a basic set of static filtering rules takes very few microseconds to check on a 20 MHz microprocessor. Therefore, it is feasible to start packet filtering at the ISR stage.

Another constraint for an ISR is the resources available for the ISR to use. For example, the input interrupt might happen when the CPU was doing a non-volatile memory write. In such a case, typically the ISR cannot do a non-volatile memory write. In general, a good programming practice, the ISR should avoid a non-volatile memory write.

A third constraint for ISR is the access to variables. An I/O interrupt might happen when the program was changing a variable. If the ISR tries to access this variable or, worse, to change the variable, the result is unpredictable. This is known as the data-sharing problem. Therefore, either the ISR should attempt to avoid access to or change a variable; or the variable must be protected, for example, using critical sections. To avoid the data-sharing problem and to reduce the interrupt latency, in a preferred embodiment of the invention access to variables in the ISR stage packet filtering 615 is not allowed. For that reason, the ISR packet filtering module 615 only checks incoming data packets 601 against static filter rules.

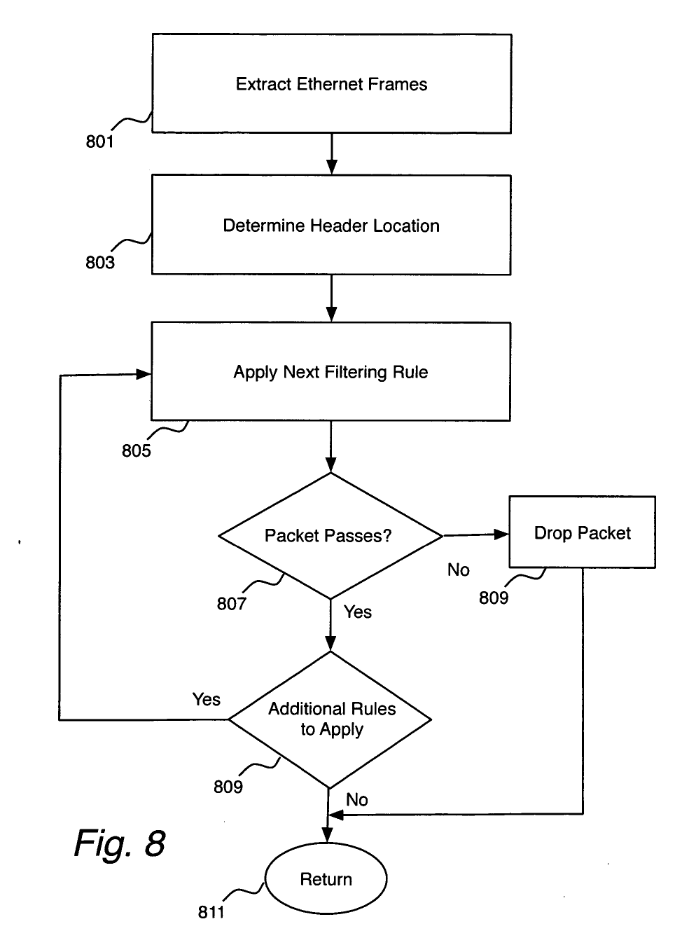

FIG. 8 is a flow chart illustrating an example sequence for the operation of the ISR packet filtering stage 615.

First the interrupt service routine extract Ethernet frames (or called packets) from the underlying link layer other than Ethernet, such as USB/CDC, USB/EEM, and MMC, step 801. For USB/CDC, this is straightforward because a USB transfer contains one and only one Ethernet frame. For USB/EEM, one USB transfer may contain more than one EEM frame. Each EEM frame carries one Ethernet frame.

Next the location of the header for the protocol to which the filter is applied is determined, step 803. Performing packet filtering inside the ISR 607 is feasible because the protocol headers, such as headers of EEM, Ethernet, and IP, are in fixed positions within their outer protocol packets. For example, the EEM packet has a two bytes header; the Ethernet packet header has fourteen bytes; and the IP header starts immediately after Ethernet header. With such fixed position, the ISR can access the header elements directly.

Having determined the proper location of the header for the next filtering rule, the next filtering rule may be applied, step 805. For the ISR packet filtering stage 615 only static filtering rules that do not depend on traffic history are applied. As noted above, static filtering rules are those rules that do not depend on any dynamic variables.

The basic packet filtering rules are very simple and involve only constants and can therefore be considered both static and stateless. The following are sample rules that are basic, that may be applied first, and that can be done in the ISR packet filtering stage 615:
Rule 1: If (Ether dest addr==my Ether addr)
   Pass the packet.
Rule 2: If the packet passed Rule 1, and if Type==IP
   Pass the packet.
Rule 3: If (Ether dest addr==ff:ff:ff:ff:ff:ff) && (Type==ARP)
   Pass the packet.
Rule 4: If the packet passed Rule 3, and if Target IP addr==my IP addr
   Pass the packet.
Rule 5: If the packet passed Rule 2, and if Dest IP addr==my IP addr
   Pass the packet.
Rule 6: If the packet passed Rule 5, and if (Protocol type==TCP) or (Protocol type==UDP) or (Protocol type==ICMP)
   Pass the packet.

If the packet does not pass the filtering rule 805, step 807, the packet is dropped 809 and the process resume processing, step 811, e.g., wait for the next incoming packet or process previously received packets. However, if the packet does pass the filtering rule 805, step 807, if there are additional rules that may be applied, step 809, the process continues with the next filtering rule, step 805.

Whether there are more rules that can be applied, step 809, depends on several factors. The first one being whether there are more rules that fit the criteria of being a rule that may be applied in the ISR packet filtering stage 615. The other being how much time is available in the ISR 607 for processing filtering rules. The latter criteria is determined during the design phase of the multi-stage packet filter. The amount of the packet filtering that can be performed in the ISR packet filtering stage 615 depends on the CPU speed, the timing constraints for the ISR 607, and the amount of necessary work that must be done. As an example mentioned earlier, for the USB bulk data transfer, the ISR has a little less than 43 microseconds. In our implementation with STMicroelectronics, Inc.'s smart card chip ST22T064, with programming in C language, the above sample rules can be executed in 55 machine cycles in the worse case scenarios. Assuming a 20 MHz microprocessor, the filtering with the above rules, in the worse case scenario, takes 2.75 microseconds. This would be reduced even further if coded in assembly language.

However, if the filtering rules are more complex or more numerous, if other processing in the ISR more time consuming, or if the timing constraints are more severe, it is possible that the timing constraints do not allow all filtering rules that could be applied in the ISR packet filtering stage 615 to have been applied at that stage. The remaining such rules are then processed in a later stage, e.g., the pre-memory allocation packet filtering stage 617.

During software development, one could measure the time needed for the normal ISR work without the packet filtering. For example, the difference of the allowable time for ISR and the measured time is the time interval that can be used for packet filtering. For some chips, there may be only time for checking one filtering rule for an Ethernet packet header; and some other chips, there may be enough time for checking all the rules for the Ethernet and some rules for the IP header.

The packet filtering at ISR is especially useful for cases where the interrupt service routines allocate memory buffer for incoming packets, as illustrated in FIG. 7. The packet filtering 615′ is performed before the memory allocation 609′. Regardless of whether the allocated memory is a single contiguous memory (for example, a byte array, or a chained memory buffer) once the ISR decides to drop the packet according to filtering rules, it will require no memory allocation and no further processing to this packet. This leads to a reduced memory usage and enhanced performance. For zero-copy protocol stack implementations, being able to drop packets at ISR still means to prevent further processing to the unwanted packets. This again enhances the performance of the system.

In addition to reduced memory usage and enhanced performance, the unwanted packet does not go further into the system. This makes the system less susceptible to network attacks and results a more secure system.

8.0 Pre-Memory Allocation Packet Filtering Stage 617

As noted in conjunction with the discussion of FIGS. 6 and 7, if the ISR is responsible for memory allocation 609, the ISR packet filtering should be performed before the memory buffer allocation for the new data packet. The memory buffer allocation may be performed outside of the ISR 607, for example, as a function of an operating system 611. In this case, the pre-memory allocation packet filtering 617 should be applied before the memory allocation 609.

With some hardware and software configurations, the interrupt service routine 607 or the Direct Memory Access (DMA) places the incoming packets into a fixed contiguous memory location. Outside of the ISR 607, the network protocol stack 613 processes and queues the packet. Before or during the protocol stack processing, the packet is taken out from the fixed memory location and placed into a dynamically allocated memory buffer or a buffer chain (The buffers may come from a buffer pool). This memory buffer or buffer chain is eventually queued for the applications 301. After the packet has been moved to the buffer chain, the contiguous memory is ready for the ISR 607 or DMA to put the next packet. The period between the return of process control from the ISR 607 and allocation of memory for the data packet is another opportunity for early packet filtering.

In one embodiment of the invention, this pre-memory-allocation packet filtering 617, if it is performed outside the ISR 607, checks an incoming data packet against all the remaining stateless filter rules, including static rules that were not checked by the ISR packet filter 615, and dynamic rules that are stateless. Once one rule decides to drop the packet, the remaining rules need not be checked and the packet is dropped. The packet filtering at this stage also prevents allocation of memory buffers for unwanted packets. The data flow is similar to that shown and discussed herein above in conjunction with FIG. 8.

One example of a dynamic filter rule that can be performed at the pre-memory-allocation packet filtering stage 617 is a rule that checks against an allowable destination port number list. Assume that the network-enabled device 101 provides a secure web server and that the allowable destination port number list initially has only one entry 443. If the network device 101 initiates a connection to a remote server using an ephemeral port number x, then x is added to the allowable destination port number list. Thus, the allowable destination port number list is dynamic and, consequently, the rule that checks against it is a dynamic packet filtering rule.

In an alternative embodiment, a hardware configuration in which the invention may be applicable is a processor with DMA (Direct Memory Access) in which the incoming data stream is transferred directly to a pre-specified contiguous memory location without passing through the CPU. The packet filtering of stateless rules can then be performed from the DMA memory to decide whether or not to drop a packet.

Note that the pre-memory-allocation packet filtering 617 in DMA case may or may not be inside the ISR 607, depending on the hardware and software configuration of the processor. If the filtering is inside the ISR 607, because of the undesirability of dealing with dynamic variables in an interrupt service route, the filtering should leave the check of the dynamic filtering rules to the next filtering stage, e.g., the protocol stack packet filtering stage 619.

9.0 Protocol Stack Packet Filtering

In one embodiment of the invention, the protocol stack includes data link layer (e.g. Ethernet), network layer (IP), and transport layer (e.g. TCP, UDP). Conventional packet filters work on the protocol stack or side-by-side to the protocol stack. With the multi-stage packet filtering according to the invention, the packet filter 619 at protocol processing stage has less to do because of the previous filtering stages 615 and 617. The packet filtering at protocol processing stage checks the remaining filter rules. In a preferred embodiment, the stateful filtering is performed by the protocol stack packet filtering stage 619 because stateful filtering requires state information not readily available in the other processing stages. The amount of filtering done by the protocol stack packet filtering stage 619 depends on the hardware and software configurations. The following are three examples.
The protocol stack packet filter does the entire packet filtering work. I.e., there is neither ISR packet filter 615 nor pre-memory-allocation packet filter 617. It should be noted that that scenario is equivalent to the conventional single-stage packet filtering approach.
The protocol stack packet filter does part of the stateless static filtering and does stateless dynamic filtering and stateful filtering. There is an ISR packet filtering stage 615, but no pre-memory-allocation packet filtering stage 617.
The protocol stack packet filter does stateful filtering only. There is an ISR packet filtering stage 615 and a pre-memory-allocation packet filtering stage 617.

10.0 Software Architecture

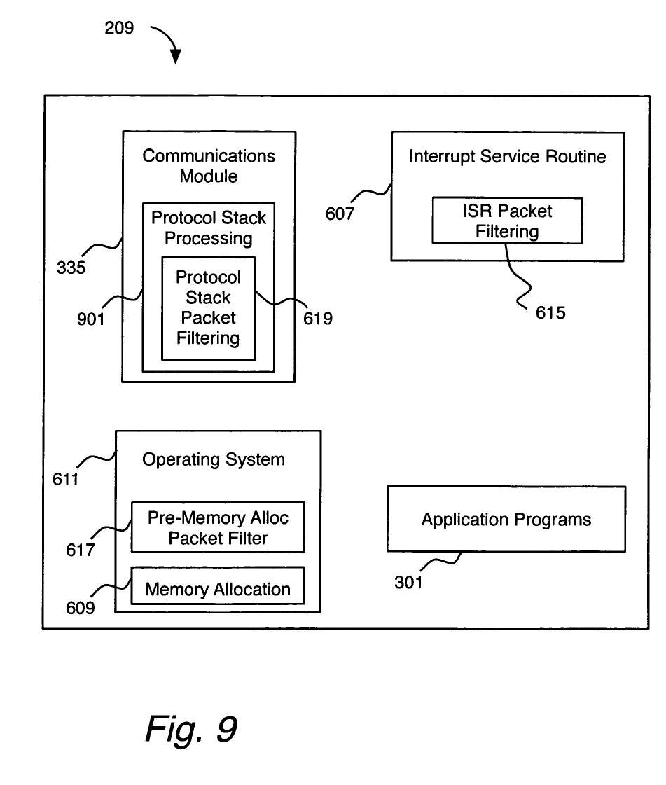

The method for multi-stage packet filtering of the present invention as described herein may be implemented as a software program or a collection of software programs having instructions for controlling the central processor unit 203 of the network-enabled device 101. These software programs would normally be stored in the NVM 209 and loaded as needed for execution into the RAM 207. FIG. 9 is a block diagram illustrating some of the software modules for implementing the multi-stage packet filtering method of the invention and that may be stored, for example, in the NVM 209.

When an incoming data packet has been received over the I/O interface 211, this event would trigger an interrupt handled by an interrupt service routine 607. In addition to the instruction necessary to cause the CPU 203 to do some initial processing of the incoming data packet, the ISR 607 may also contain instructions to perform the functions of ISR packet filtering stage 615.

The operations of the network-enabled device 101 is controlled by an operating system 611. The operating system 611 provides instructions to the CPU 203. One functionality provided by the operating system 611 instructions may include memory allocation 609 for incoming data packets. The operating system 611 may also contain instructions to cause the CPU 203 to perform the pre-memory allocation packet filtering stage 617.

The software programs stored in the NVM 209 also include the communications module 335 which implements a communications protocol stack processing module 901. The communications protocol stack would, in one embodiment, include instructions to cause the CPU to process the various protocol layers 319-329. As noted herein above, other protocols may also be implemented or in lieu of these protocols. The protocol stack processing also includes the processing of the protocol stack packet filtering stage 619. In other words, the protocol stack processing module 901 contains instructions to cause the CPU 203 to perform the protocol stack packet filtering stage 619.

Finally, the NVM 209 may include some application programs 301, which are the ultimate consumers of the incoming data packets that have passed all the filtering rules processed by the multi-stage packet filtering system according to the present invention.

11.0 Conclusion

The multi-stage packet filtering method according to the invention drops unwanted packets as soon as possible to build a network firewall inside a network-enabled device 101, e.g., a network smart card. Packet filtering system designed according to the invention saves memory resources and reduces CPU usage for packet processing. The multi-stage packet filtering system and method of the invention is a general framework for efficient packet filtering for small resource constrained network devices. The invention may advantageously be employed in a variety of hardware and software configurations and with various filter rules. The multi-stage packet filtering system of the present invention has several advantages over existing packet filtering designs, including better security, reduced memory usage, and enhanced performance. The approach is applicable to a variety of small resource constrained embedded network devices for their security and success on the Internet.

Although specific embodiments of the invention have been described and illustrated, the invention is not to be limited to the specific forms or arrangements of parts so described and illustrated. The invention is limited only by the claims.

We claim:

1. A method for packet filtering in a network-enabled device according to a set of filtering rules wherein filtering rules are applied early in the processing of incoming communications packets, comprising:
filtering incoming data packets using the filtering rules in a plurality of stages wherein the first stage is triggered by the receipt of a data packet by the network-enabled device.

2. The method of packet filtering in a network-enabled device of claim 1 wherein the filtering rules includes rules classified based on whether the filtering rule is a dynamic rule that tests a packet against dynamic variables or a static rule that tests a packet against constants or variables that do not change during a session of the network-enabled device wherein the first stage executes as part of an interrupt service routine for handling the incoming data packet applies static rules.

3. The method of packet filtering in a network-enabled device of claim 2 further comprising applying any of the static filtering that could not be applied during the interrupt service routine due to timing constraints during a pre-memory allocation packet filtering stage.

4. The method of packet filtering in a network-enabled device of claim 2 wherein filtering rules that include dynamic variables are applied during a pre-memory allocation packet filtering stage.

5. The method of packet filtering in a network-enabled device of claim 2 wherein memory allocation for incoming packets is performed in the interrupt service routine triggered by an incoming data packet and the first stage of packet filtering is performed prior to the memory allocation.

6. The method of packet filtering in a network-enabled device of claim 1 in which a plurality of packet filtering rules are protocol specific and in which the protocol specific packet filtering rules are classified as those filtering rules that depend on traffic history and those filtering rules that do not depend on traffic history wherein the method further comprises:
applying the filtering rules that do not depend on traffic history in a pre-memory allocation packet filtering stage; and
applying the filtering rules that do depend on traffic history during a protocol specific packet filtering stage.

7. The method of packet filtering in a network-enabled device of claim 6 wherein the protocol specific filtering rules are specific to the TCP communications protocol and are applicable to filter TCP packets and wherein the filtering rules that do not depend on traffic history are stateless TCP packet filtering rules and the filtering rules that do depend on traffic history are stateful TCP packet filtering rules.

8. The method of packet filtering in a network-enabled device of claim 1 wherein the packet filtering rules are classified by a first property being as to whether the filtering rule depends on traffic history and a second property as to whether the filtering rule includes dynamic variables, the method further comprising:
applying the filtering rules that do not depend on traffic history and which do not include dynamic variables in the first stage;
applying the filtering rules that do not depend on traffic history and which do include dynamic variables in a pre-memory allocation stage;
applying the filtering rules that do depend on traffic history in a protocol specific packet filtering stage.

9. A network-enabled device having a central processing unit and a memory for storing software modules having instructions controlling the central processing unit, the network-enabled device implementing packet filtering system according to a set of filtering rules wherein filtering rules are applied as early as possible, the software modules comprising instructions for:
filtering incoming data packets using the filtering rules in a plurality of stages wherein the first stage is triggered by the receipt of a data packet by the network-enabled device.

10. The network-enabled device implementing packet filtering system according to a set of filtering rules of claim 9 wherein the filtering rules includes rules classified based on whether the filtering rule is a dynamic rule that tests a packet against dynamic variables or a static rule that tests a packet against constants or variables that do not change during a session of the network-enabled device wherein the first stage executes as part of an interrupt service routine for handling the incoming data packet applies static rules.

11. The network-enabled device implementing packet filtering system according to a set of filtering rules of claim 10 wherein the software modules further comprise instructions for applying any of the static filtering that could not be applied during the interrupt service routine due to timing constraints during a pre-memory allocation packet filtering stage.

12. The network-enabled device implementing packet filtering system according to a set of filtering rules of claim 10 wherein software modules comprise instructions causing the filtering rules that include dynamic variables to be applied during a pre-memory allocation packet filtering stage.

13. The network-enabled device implementing packet filtering system according to a set of filtering rules of claim 10 wherein the software modules comprise instructions causing the memory allocation for incoming packets to be performed in the interrupt service routine triggered by an incoming data packet and the first stage of packet filtering is performed prior to the memory allocation.

14. The network-enabled device implementing packet filtering system according to a set of filtering rules of claim 9 in which a plurality of packet filtering rules are protocol specific and in which the protocol specific packet filtering rules are classified as those filtering rules that depend on traffic history and those filtering rules that do not depend on traffic history wherein the software modules further comprising instructions for:
applying the filtering rules that do not depend on traffic history in a pre-memory allocation packet filtering stage or; and
applying the filtering rules that do depend on traffic history in during a protocol specific packet filtering stage.

15. The network-enabled device implementing packet filtering system according to a set of filtering rules of claim 14 wherein the protocol specific filtering rules are specific to the TCP communications protocol and are applicable to filter TCP packets and wherein the filtering rules that do not depend on traffic history are stateless TCP packet filtering rules and the filtering rules that do depend on traffic history are stateful TCP packet filtering rules.

16. The network-enabled device implementing packet filtering system according to a set of filtering rules of claim 9 wherein the packet filtering rules are classified by a first property being as to whether the filtering rule depends on traffic history and a second property as to whether the filtering rule includes dynamic variables, the software module further comprising instructions for:
applying the filtering rules that do not depend on traffic history and which do not include dynamic variables in the first stage;
applying the filtering rules that do not depend on traffic history and which do include dynamic variables in a pre-memory allocation stage;
applying the filtering rules that do depend on traffic history in a protocol specific packet filtering stage.
